(19) United States
(12) Patent Application Publication
(10) Pub. No.: US 2009/0171772 A1
(43) Pub. Date: Jul. 2, 2009

(54) RNSS-based lane-level vehicle tolling method and system

(76) Inventors: Gregory C. Petrisor, Los Angeles, CA (US); Ryan A. Perdue, Venice, CA (US); Larry B. Deer, Ridgeland, MS (US); Lawrence E. Sweeney, JR., Atherton, CA (US)

Correspondence Address: Scot A. Reader, Suite 228, 1320 Pearl Street, Boulder, CO, 80302, US

(21) Appl. No.: 12/317,634

(22) Filed: Dec. 23, 2008

Related U.S. Application Data
(60) Provisional application No. 61/009,700, filed on Dec. 31, 2007.
(60) Provisional application No. 61/009,701, filed on Dec. 31, 2007.
(60) Provisional application No. 61/009,965, filed on Jan. 4, 2008.
(60) Provisional application No. 61/195,300, filed on Oct. 6, 2008.

(51) Int. Cl. G06Q 99/00

(52) U.S. Cl. 705/13

(57) ABSTRACT

An RNSS-based lane-level vehicle tolling method and system for a roadway having at least one managed traffic lane and at least one unmanaged traffic lane, and on-vehicle equipment for use therein, overcome lane identification limitations of RNSS-based tolling and achieves lane-level tolling through explicit lane identification. In some embodiments, a vehicle transmits a lane presence indication (LPI) to indicate to off-vehicle toll processing whether the vehicle is currently in a managed or unmanaged traffic lane. In other embodiments, on-vehicle toll processing uses lane identification information locally to determine whether the vehicle is currently in a managed or unmanaged traffic lane.

### CROSS-REFERENCE TO RELATED APPLICATIONS

This application claims the benefit of U.S. provisional application Nos. 61/009,700 entitled “Real-Time, Lane-Level Tolling System with Human Lane Identification,” filed on Dec. 31, 2007; 61/009,701 entitled “Real-Time, Lane Level Tolling System,” filed on Dec. 31, 2007; 61/009,965 entitled “Real-Time, Lane-Level Tolling System with Human Lane Identification and Wheel Tachometer Information,” filed on Jan. 4, 2008; and 61/195,300 entitled “Real-Time, Lane-Level Tolling System with Human Lane Identification and Off Board Processing,” filed on Oct. 6, 2008, all of which are incorporated herein by reference.

### BACKGROUND OF THE INVENTION

The present invention relates to vehicle tolling for a roadway and, more particularly, to a radio navigation satellite system (RNSS)-based lone-level vehicle tolling method and system for a roadway and on-vehicle equipment for use therein.

Traffic congestion has become a significant impediment to the quality of life in urban areas. Physical road capacity (lane-miles) of the nation's roadway system has grown slowly over the last quarter century whereas vehicle miles traveled have grown rapidly over the same period. The United States Department of Transportation (USDOT) has indicated that there are insufficient resources to build additional physical road capacity at a rate to keep up with demand. High costs to add physical road capacity and long timelines for deployment have led to anemic growth in physical road capacity in some urban areas.

USDOT has promoted carpooling as an alternative to adding road capacity. To promote carpooling, USDOT has incentivized states to create high occupancy vehicle (HOV), more commonly known as carpool lanes, whose lawful usage is typically limited to vehicles with multiple occupants. As a result, most states now have networks of HOV lanes in congested areas. In the peak of rush hour conditions, HOV lanes may at times reach full capacity. However, there is often a significant amount of excess capacity that goes unutilized even during rush hour conditions.

Some states have liberalized access to HOV lanes in order to use some of this excess capacity. For example, California has issued stickers to owners of qualifying hybrid vehicles that allow these vehicles to lawfully access HOV lanes even when carrying a single occupant. This has led to greater utilization of HOV lanes; however, in congested areas it has adversely impacted carpoolers.

Additionally, several variants of HOV lane tolling have been proposed or deployed that allow utilization of excess HOV lane capacity by single occupant vehicles on a charge basis. These systems have generally called for installation of radio frequency identification (RFID) tags in single occupant vehicles and the deployment of periodic gantries along a barrier-free HOV lane with signage that announces current toll rates. RFID readers in the gantries read the RFID tags in passing vehicles and charge the single occupant for use of the HOV lane, monitor current congestion, and dynamically adjust HOV lane toll rates for single occupant vehicles in response to current congestion. A downside of RFID-based barrier-free HOV lane tolling systems is the need for a high density of signage and a high density of roadside gantries to read RFID tags in passing vehicles for the purposes of charging occupants for use of the HOV lane and accurately assessing congestion so that HOV lane toll rates can be properly adjusted. These requirements make known RFID-based HOV lane tolling systems expensive to deploy and operate.

Meanwhile, it is known to use on-vehicle RNSS receivers, such as Global Positioning System (GPS) receivers, in vehicle tolling applications. However, RNSS receivers are not known to have been used in lane-level vehicle tolling applications. Indeed, RNSS receivers alone are not known to achieve a level of accuracy in lane identification required by such applications. For example, the horizontal positioning error of known GPS receivers due to satellite clock error, atmospheric refraction, receiver noise and other causes is too great to confidently determine whether a vehicle on a roadway having a managed traffic lane (e.g. HOV lane) and unmanaged traffic lanes is in the managed traffic lane. Differential correction can somewhat improve the accuracy of RNSS-based lane identification, but not enough to meet lane-level vehicle tolling application requirements.

### SUMMARY OF THE INVENTION

The present invention, in a basic feature, provides an RNSS-based lane-level vehicle tolling method and system for a roadway having at least one managed traffic lane and at least one unmanaged traffic lane and on-vehicle equipment for use therein. The present invention overcomes lane identification limitations of RNSS-based tolling and achieves lane-level tolling through explicit lane identification. In some embodiments, a vehicle transmits a lane presence indication (LPI) to indicate to off-vehicle toll processing whether the vehicle is currently in a managed or unmanaged traffic lane. In other embodiments, on-vehicle toll processing uses lane identification information locally to determine whether the vehicle is currently in a managed or unmanaged traffic lane.

In one aspect of the invention, an RNSS-based lane-level vehicle tolling system comprises on-vehicle equipment, off-vehicle equipment and a wireless link, wherein the on-vehicle equipment transmits to the off-vehicle equipment via the wireless link vehicle position information determined using RNSS signals and a LPI and in response the on-vehicle equipment receives from the off-vehicle equipment via the wireless link toll information that is outputted to an occupant of the vehicle.

In some embodiments, the vehicle position information is further determined using pseudolite signals.

In some embodiments, the vehicle position information is further determined using wheel tachometer information.

In some embodiments, the on-vehicle equipment further receives from the off-vehicle equipment via the wireless link differential correction information and the vehicle position information is further determined using the differential correction information.

In some embodiments, the LPI comprises an indication that the vehicle is in a managed lane.

In some embodiments, the LPI comprises an indication that the vehicle is in an unmanaged lane.

In some embodiments, the toll information comprises toll rate information.

In some embodiments, the toll information comprises trip charge information.

In another aspect of the invention, on-vehicle equipment comprises a processor, a position receiver communicatively coupled with the processor, a human machine interface (HMI) communicatively coupled with the processor and a wireless transceiver communicatively coupled with the processor, wherein under control of the processor the on-vehicle equipment transmits via the wireless transceiver vehicle position information determined using RNSS signals received by the position receiver and a LPI determined using information received by the HMI and in response receives via the wireless transceiver toll information, and wherein under control of the processor the on-vehicle equipment outputs the toll information on the HMI.

In some embodiments, the signals received by the position receiver further comprise pseudolite signals and the vehicle position information is further determined using pseudolite signals.

In some embodiments, the on-vehicle equipment further comprises a wheel tachometer and the vehicle position information is further determined using information received from the wheel tachometer.

In some embodiments, the vehicle position information is further determined using differential correction information received via the wireless transceiver.

In some embodiments, the LPI comprises an indication that the vehicle is in a managed lane.

In some embodiments, the LPI comprises an indication that the vehicle is in an unmanaged lane.

In some embodiments, the toll information comprises toll rate information.

In some embodiments, the toll information comprises trip charge information.

In another aspect of the invention, an RNSS-based lane-level vehicle tolling method comprises the steps of transmitting vehicle position information determined using RNSS signals and a LPI, receiving toll information in response to the vehicle position information and the LPI, and outputting the toll information.

In yet another aspect of the invention, an RNSS-based lane-level vehicle tolling method comprises the steps of receiving roadway toll information from off-vehicle equipment; receiving RNSS signals, receiving lane identification information; determining vehicle toll information using the roadway toll information, vehicle position information determined using the RNSS signals and the lane identification information; and outputting the vehicle toll information.

These and other aspects of the invention will be better understood by reference to the following detailed description taken in conjunction with the drawings that are briefly described below.

### BRIEF DESCRIPTION OF THE DRAWINGS

FIG. 1 shows a communication system in which an RNSS-based lane-level vehicle tolling system and method are operative in some embodiments.

FIG. 2 shows steps of an RNSS-based lane-level vehicle tolling method performed by on-vehicle equipment in some embodiments.

FIG. 3 shows steps of an RNSS-based lane-level vehicle tolling method performed by off-vehicle equipment in some embodiments.

FIG. 4 shows steps of an RNSS-based lane-level vehicle tolling method performed by on-vehicle equipment in other embodiments.

### DETAILED DESCRIPTION OF A PREFERRED EMBODIMENT

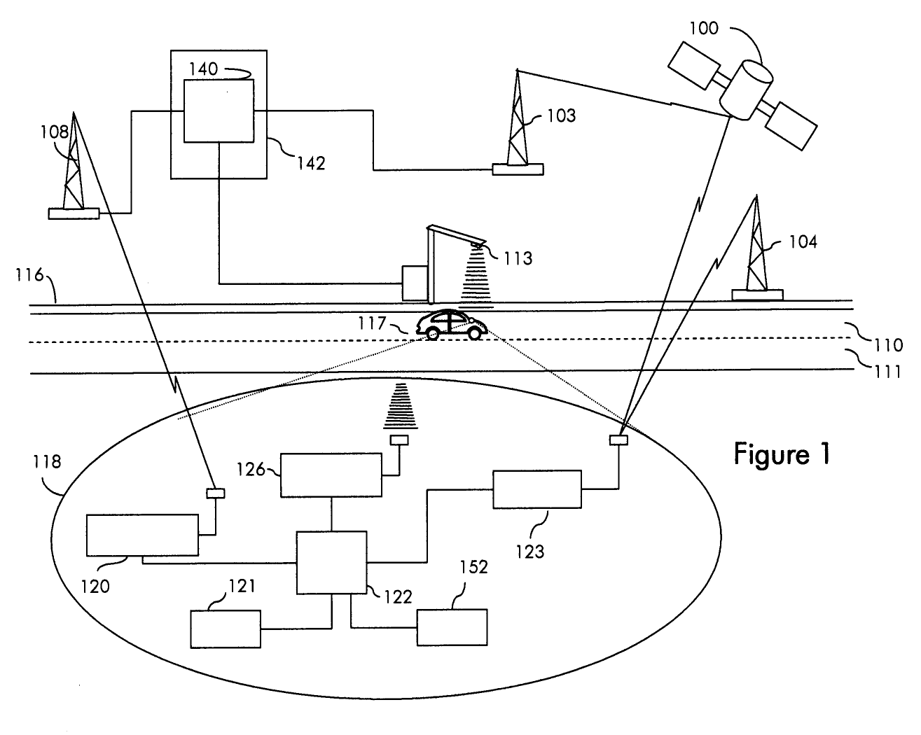

FIG. 1 shows a communication system in which an RNSS-based lane-level vehicle tolling system and method are operative in some embodiments. The communication system includes a vehicle 117 traveling on a roadway 16 and a network operations center 142 remote from roadway 116. Roadway 116 has a managed traffic lane 10 and an unmanaged traffic lane 111. Vehicle is a wheeled passenger vehicle, such as a car, truck, sport utility vehicle, minivan or the like. Use of managed traffic lone 110 by vehicle 117 requires payment of a toll whereas use of unmanaged traffic lane 111 is toll-free. Vehicle 117 has on-vehicle equipment 118 thereon and network operations center 142 has off-vehicle equipment 140 therein.

In operation, position receiver 123 receives RNSS signals from RNSS satellites 100 and radio navigation pseudolite signals from pseudolite 104 and computes vehicle geoposition information from these signals. The RNSS signals may be GPS signals, for example. The vehicle geoposition information includes a latitude and longitude of vehicle 117, for example. Position receiver 123 transmits the vehicle geoposition information to an on-vehicle processor 122.

On-vehicle processor 122 separately receives wheel tachometer information from wheel tachometer 152 and differential correction information from off-vehicle equipment 140 via wireless transceiver 120. In this regard, RNSS base station 103 receives RNSS signals from RNSS satellites 100 and transmits RNSS measurement information to off-vehicle equipment 140. Off-vehicle equipment 140 computes differential correction information from the RNSS measurement information and transmits the differential correction information to on-vehicle equipment 118 via wireless base station 108. On-vehicle processor 122 uses the wheel tachometer information and differential correction information to ad just the vehicle geoposition information received from position receiver 123 and improve its accuracy.

On-vehicle processor 122 also receives lane identification information from an HMI 121. HMI 121 has an input mechanism, such as a keyboard, keypad or touch screen for accepting inputs from a vehicle occupant and an output mechanism, such as a liquid crystal display (LED) or light emitting diode (LED) display, for displaying outputs to a vehicle occupant. HMI 121 transmits lane identification information to on-vehicle processor 122 in response to input of lane identification information by a vehicle occupant on an input mechanism of HMI 121. Lane identification information is sufficient to inform on-vehicle processor whether vehicle 117 is in managed lane 110 or unmanaged lane 111. On-vehicle processor 122 uses lane identification information received from HMI 121 to generate a LPI that indicates whether vehicle 117 is in managed lane 110 or unmanaged lane 111. In some embodiments, the LPI may be transmitted as a single bit in a designated field of a position report, wherein “1” indicates presence in managed lane 110 and “0” indicates presence in unmanaged lane 111. Prior to receiving initial lane identification information from HMI 121, on-vehicle processor 122 assumes that vehicle 117 is in an unmanaged lane and generates a LPI that indicates such.

On-vehicle processor 122 generates position reports having vehicle geoposition information and a LPI and transmits position reports to off-vehicle equipment 140 via wireless transceiver 120.

In some embodiments, on-vehicle processor 122 receives vehicle geoposition information, wheel tachometer information and differential correction information periodically while vehicle 117 is on roadway 116, receives lane identification information episodically when vehicle 117 enters or exits managed lane 110, and transmits position reports including vehicle geoposition information and a MLPI periodically to off-vehicle equipment 140 while vehicle 117 is on roadway 116.

Off-vehicle equipment 140 receives position reports having vehicle geoposition information and a LPI from on-vehicle equipment 118 and responds with toll reports having toll information. Off-vehicle equipment 140 determines current toll rate information for vehicle 117 by matching vehicle geoposition information in position reports to entries in a toll rate map database. The units for toll rate information may be, for example, in dollars per mile. Off-vehicle equipment 140 also determines whether the LPI in position reports indicates that vehicle 117: (1) continues in unmanaged lane 111, (2) continues in managed lane 110, (3) has entered managed lane 110 or (4) has exited managed lane 111. If off-vehicle equipment 140 determines that vehicle 117 continues in unmanaged lane 111, as established by the LPI in the current and immediately preceding position report (if any) from vehicle 117 indicating the presence of vehicle 117 in unmanaged lane 111, off-vehicle equipment 140 transmits the current toll rate information to on-board equipment 118. If off-vehicle equipment 140 determines that vehicle 117 continues in managed lane 110, as established by the LPI in the current and immediately preceding position report indicating the presence of vehicle 117 in managed lane 110, off-vehicle equipment 140 computes current trip charge information for vehicle 117 as the sum of the previous trip charge information and the distance traveled between the current and immediately preceding position report multiplied the current toll rate. If off-vehicle equipment 140 determines that vehicle 117 has entered managed lane 110, as established by the LPI in the current position report indicating the presence of vehicle 117 in managed lane 110 and the LPI in the immediately preceding position report indicating the presence of vehicle 117 in unmanaged lane 111, off-vehicle equipment 140 computes initial trip charge information for vehicle 117 as the applicable managed lane entry fee, if any. Finally, if off-vehicle equipment 140 determines that vehicle 117 has exited managed lane 110, as established by the LPI in the current position report indicating the presence of vehicle 117 in unmanaged lane 111 and the LPI in the immediately preceding position report indicating the presence of vehicle 117 in managed lane 110, off-vehicle equipment 140 computes final trip charge information for vehicle 117 as the sum of the previous trip charge information, the applicable managed lane exit fee, if any, and the distance traveled between the current and immediately preceding position report multiplied the current toll rate, and off-vehicle equipment 140 proceeds to bill the account of the registered owner of vehicle 117 as per the final trip charge information. Off-vehicle equipment 140 transmits to on-vehicle equipment 118 via wireless transceiver 120 toll reports having toll information, including toll rates and trip charge information, as applicable. Off-vehicle equipment 140 stores time-stamped position reports received from vehicle 117 and trip charge information for vehicle 117 in an active trip database.

On-vehicle processor 122 receives toll reports having toll information from wireless transceiver 120 and transmits toll information from toll reports to HUI 240, which displays the toll information on an output device. As a result, a vehicle occupant traveling in unmanaged lane 111 is able to view the current toll rate and make an informed decision as to whether and when to enter managed lane 110, and a vehicle occupant traveling in managed lane 110 is similarly able to view the current toll rate and trip charge and make an informed decision as to whether and when to exit managed lane 110.

Additionally, an RFID tag reader 113 operating on the side of roadway 116 reads an RFID tag 126 on vehicle 117 and reports the RFID to off-board equipment 140 in order to verify that the occupant of vehicle 117 has reported his or her use of managed lane 110. If the vehicle occupant 117 has not reported his or her use of managed lane 110, he or she can be subjected to administrative sanction, such as a fine.

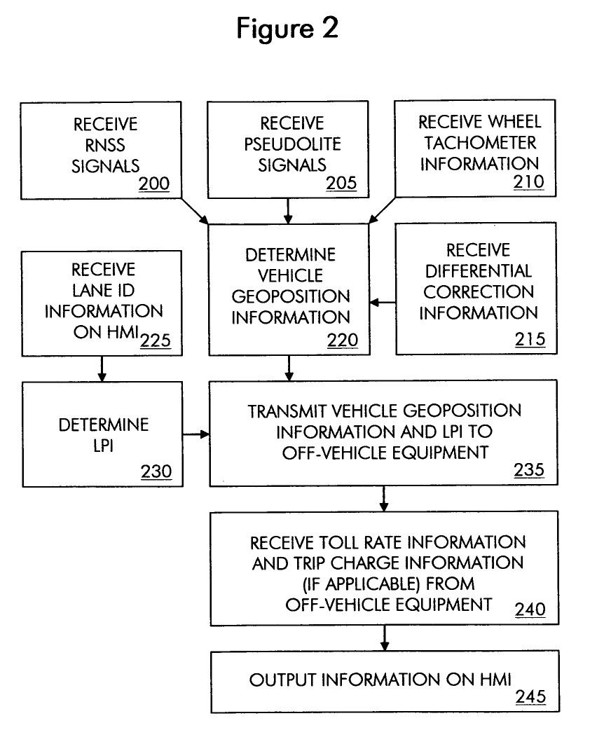

Turning now to FIG. 2, steps of an RNSS-based lane-level vehicle tolling method performed by on-vehicle equipment 118 are shown in some embodiments. On-vehicle equipment 118 receives RNSS signals (200), pseudolite signals (205), wheel tachometer information (210) and differential correction information (215) and uses the acquired information to periodically determine vehicle geoposition information (220). On-vehicle equipment 118 also episodically receives lane identification information generated based on user input on HMI 121 (225) and determines a LPI (230). On-vehicle equipment 118 periodically generates position reports having vehicle geoposition information and a LPI and transmits the reports to off-vehicle equipment 140 (235). In response, on-vehicle equipment 118 receives from off-vehicle equipment 140 toll reports having toll rate information and, if applicable, trip charge information (240) that on-vehicle equipment 118 outputs on HUI 121 (245).

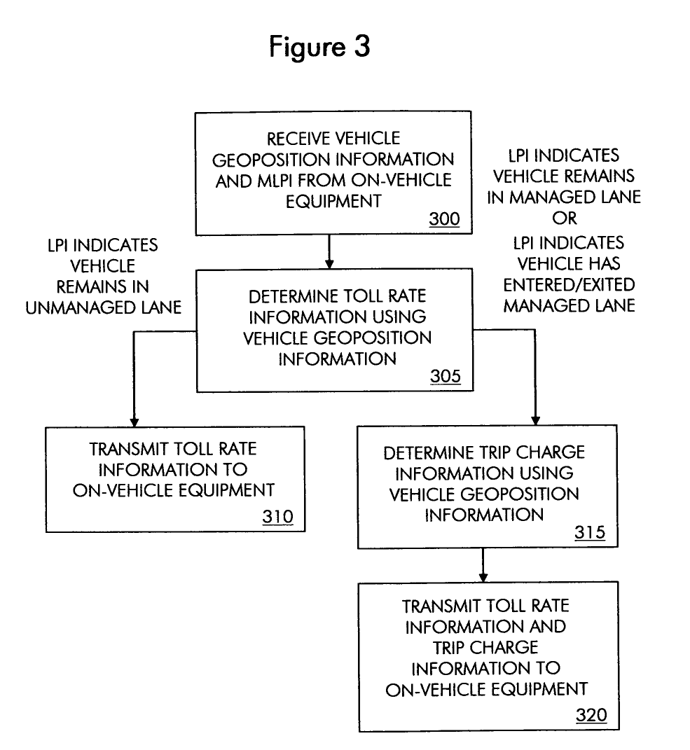

Referring finally to FIG. 3, steps of an RNSS-based lane-level vehicle tolling method performed by off-vehicle equipment 140 are shown in some embodiments. Off-vehicle equipment 140 periodically receives from on-vehicle equipment 118 position reports including vehicle geoposition information and a LPI (300). In response to each position report, off-vehicle equipment 140 determines toll rate information using the vehicle geoposition information from the position report (305). If the LPI from the position report indicates that the reporting vehicle 117 remains in unmanaged lane 111, off-vehicle equipment 140 generates a toll report having the toll rate information and transmits the report to on-vehicle equipment 118 (310). If, however, the LPI from the position report indicates that the reporting vehicle 117 remains in managed lane 110, or that the reporting vehicle has entered or exited managed lane 110, off-vehicle equipment 140 additionally determines trip charge information using the vehicle geoposition information in the position report (315), generates a toll report having the toll rate information and the trip charge information and transmits the report to on-vehicle equipment 118 (320).

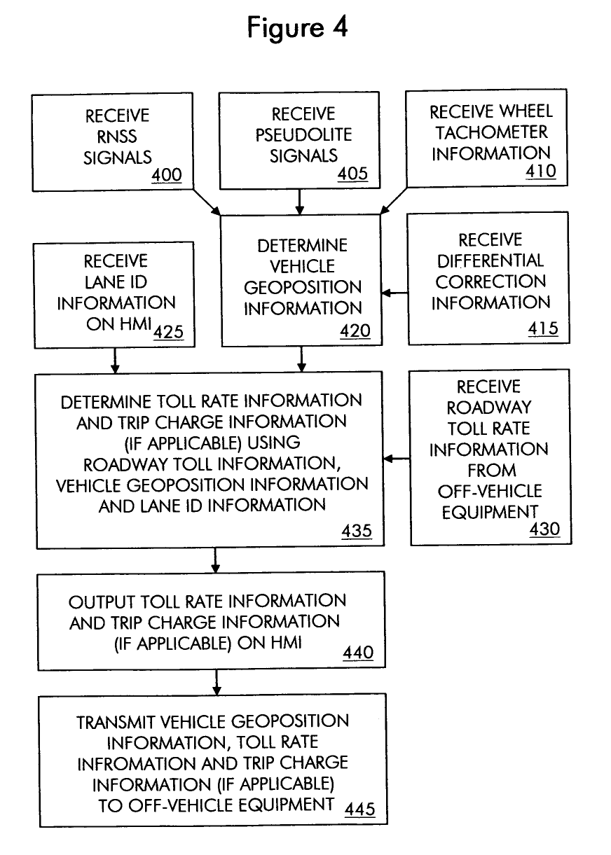

FIG. 4 shows steps of an RNSS-based lane-level vehicle tolling method performed by on-vehicle equipment in other embodiments of the invention. In these embodiments, on-vehicle equipment locally determines and outputs vehicle toll information and transmits the locally determined vehicle toll information to off-vehicle equipment for tracking purposes. More particularly, on-vehicle equipment receives RNSS signals (400), pseudolite signals (405), wheel tachometer information (410) and differential correction information (415) and uses the acquired information to periodically determine vehicle geoposition information (420). On-vehicle equipment also episodically receives lone identification information generated based on user input on a vehicle HMI (425). On-vehicle equipment additionally receives roadway toll rate information broadcast by off-vehicle equipment (430). The roadway toll rate information includes current toll rates applicable to various segments of the roadway and is provided without reference to the particular segment of the roadway that the vehicle is on. On-vehicle equipment determines vehicle toll rate information and, if applicable, vehicle trip charge information using the vehicle geoposition information, roadway toll rate information and lane identification information (435) and outputs the vehicle toll rate information and, if applicable, the vehicle trip charge information on the vehicle HMI (440) (440). On-vehicle equipment also transmits the vehicle geoposition information, vehicle toll rate information and vehicle trip charge information to off-vehicle equipment for tracking purposes (445).

The components of the systems described herein may perform their respective operations using various combinations of custom logic and software.

It will be appreciated by those of ordinary skill in the art that the invention can be embodied in other specific forms without departing from the spirit or essential character hereof. By way of example, in some embodiments of the invention vehicle geoposition information is determined without use of pseudolite signals, wheel tachometer information and/or differential correction information. Moreover, in some embodiments a LPI may be generated based on a lane identification made by an automated system without user input. Moreover, in some embodiments of the invention operations described as being performed on on-vehicle equipment 118 are performed on off-vehicle equipment 140, or vice versa. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A radio navigation satellite system (RNSS)-based lane-level vehicle tolling system, comprising:
on-vehicle equipment;
off-vehicle equipment; and
a wireless link, wherein the on-vehicle equipment transmits to the off-vehicle equipment via the wireless link vehicle position information determined using RNSS signals and a lane presence indication (LPI) and in response the on-vehicle equipment receives from the off-vehicle equipment via the wireless link toll information that is outputted to an occupant of the vehicle.

2. The tolling system of claim 1, wherein the vehicle position information is further determined using pseudolite signals.

3. The tolling system of claim 1, wherein the vehicle position information is further determined using wheel tachometer information.

4. The tolling system of claim 1, wherein the on-vehicle equipment further receives from the off-vehicle equipment via the wireless link differential correction information and the vehicle position information is further determined using the differential correction information.

5. The tolling system of claim 1, wherein the LPI comprises an indication that the vehicle is in a managed lane.

6. The tolling system of claim 1, wherein the LPI comprises an indication that the vehicle is in an unmanaged lane.

7. The tolling system of claim 1, wherein the toll information comprises toll rate information.

8. The tolling system of claim 1, wherein the toll information comprises trip charge information.

9. On-vehicle equipment, comprising:
a processor;
a position receiver communicatively coupled with the processor;
a human machine interface (HMI) communicatively coupled with the processor; and
a wireless transceiver communicatively coupled with the processor, wherein under control of the processor the on-vehicle equipment transmits via the wireless transceiver vehicle position information determined using RNSS signals received by the position receiver and a LPI determined using information received by the HMI and in response receives via the wireless transceiver toll information, and wherein under control of the processor the on-vehicle equipment outputs the toll information on the HMI.

10. The on-vehicle equipment of claim 9, wherein the signals received by the position receiver further comprise pseudolite signals and the vehicle position information is further determined using pseudolite signals.

11. The on-vehicle equipment of claim 9, further comprising a wheel tachometer, wherein the vehicle position information is further determined using information received from the wheel tachometer.

12. The on-vehicle equipment of claim 9, wherein the vehicle position information is further determined using differential correction information received via the wireless transceiver.

13. The on-vehicle equipment of claim 9, wherein the LPI comprises an indication that the vehicle is in a managed lane.

14. The on-vehicle equipment of claim 9, wherein the LPI comprises an indication that the vehicle is in an unmanaged lane.

15. The on-vehicle equipment of claim 9, wherein the toll information comprises toll rate information.

16. The on-vehicle equipment of claim 9, wherein the toll information comprises trip charge information.

17. An RNSS-based lane-level vehicle tolling method, comprising the steps of:
transmitting vehicle position information determined using RNSS signals and a LPI;
receiving toll information in response to the vehicle position information and the LPI; and
outputting the toll information.

18. The method of claim 17, wherein the vehicle position information is further determined using pseudolite signals.

19. The method of claim 17 wherein the vehicle position information is further determined using wheel tachometer information.

20. The method of claim 17, wherein the vehicle position information is further determined using the differential correction information.

21. The method of claim 17, wherein the LPI comprises an indication that the vehicle is in a managed lane.

22. The method of claim 17, wherein the LPI comprises an indication that the vehicle is in an unmanaged lane.

23. The method of claim 17, wherein the toll information comprises toll rate information.

24. The method of claim 17, wherein the toll information comprises trip charge information.

25. An RNSS-based lane-level vehicle tolling method, comprising the steps of:
receiving roadway toll information from off-vehicle equipment;
receiving RNSS signals;
receiving lane identification information;
determining vehicle toll information using the roadway toll information, vehicle position information determined using the RNSS signals and the lane identification information; and
outputting the vehicle toll information.

26. The method of claim 25, wherein the lane identification information indicates presence in a managed lane and the vehicle toll information comprises toll rate information and trip charge information.

27. The method of claim 25, wherein the lane identification information indicates presence in an unmanaged lane and the vehicle toll information comprises toll rate information.

28. The method of claim 25, further comprising the step of transmitting the vehicle position information to the off-vehicle equipment.

29. The method of claim 25, further comprising the step of transmitting the vehicle toll information to the off-vehicle equipment.

30. The method of claim 25, wherein the vehicle position information is further determined using pseudolite signals.

31. The method of claim 25, wherein the vehicle position information is further determined using wheel tachometer information.

32. The method of claim 25, further comprising the step of receiving differential correction information from the off-vehicle equipment, wherein the vehicle position information is further determined using the differential correction information.
